(19) United States
(12) Patent Application Publication
(10) Pub. No.: US 2015/0086092 A1
(43) Pub. Date: Mar. 26, 2015

(54) MEDICAL DIAGNOSTIC IMAGING APPARATUS, MEDICAL IMAGE DISPLAY APPARATUS, AND MEDICAL IMAGE DISPLAY METHOD

(71) Applicants: KABUSHIKI KAISHA TOSHIBA, Tokyo (JP); TOSHIBA MEDICAL SYSTEMS CORPORATION, Otawara-Shi (JP)

(72) Inventors: Yoshikatsu ITADA, Yaita (JP); Shinichi UCHIZONO, Nasushiobara (JP); Kazuo HIGUCHI, Nasushiobara (JP); Takuya FUJIMAKI, Otawara (JP)

(21) Appl. No.: 14/498,536

(22) Filed: Sep. 26, 2014

(30) Foreign Application Priority Data
Sep. 26, 2013 (JP) 2013-200441

(51) Int. Cl. G06T 7/00; G06K 9/46; G06F 17/30

(52) U.S. Cl. CPC G06T 7/0012; G06F 17/30244; G06K 9/4604
USPC 382/128

(57) ABSTRACT

A medical diagnostic imaging apparatus includes an execution unit configured to execute a plurality of imaging protocols included in an examination; and a display control unit configured to display a first screen and a second screen, where the first screen selectably displays a plurality of image datasets collected based on the respective imaging protocols after execution of the plurality of imaging protocols as well as extracts and displays postprocessing applications applicable to individual ones of the image datasets while the second screen is brought up by transitioning from the first screen and used to perform postprocessing of the image datasets, wherein when an application associated with a predetermined image dataset is selected on the first screen, the display control unit starts the selected application and transitions from the first screen to the second screen to perform postprocessing of the predetermined image dataset.

### FIELD

An exemplary embodiment of the present invention relates to a medical diagnostic imaging apparatus, medical image display apparatus, and medical image display method.

### BACKGROUND

Acquisition of medical images with a medical diagnostic imaging apparatus (hereinafter referred to as a modality apparatus) used in medical scenes allows a diagnosis to be made by watching internal parts of the body without damaging the body, and is thus an indispensable technology in modern medical care. Along with advances and performance improvements of the modality apparatus, a wide variety of modality apparatus have been developed according to various body sites and disease detection measures. Furthermore, along with advancement in digitalization of medical images and development of PACS (Picture Archiving and Communication Systems) and HIS (Hospital Information System), an environment surrounding medical care has increasingly been computerized. As a result, medical images acquired by modality apparatus have also come to be converted into electronic data.

On the other hand, with diversification of modality apparatus and diversification of imaging methods, different operations and inputs have come to be required of users depending on the modality apparatus and imaging method. Consequently, operations used to enter various settings in the modality apparatus have become complicated. In addition, one examination is often made up of a combination of plural units of imaging (hereinafter referred to as imaging protocols) which use different imaging methods, and it is a heavy burden for the user to make the settings manually with respect to all the imaging protocols.

Thus, medical diagnostic imaging apparatus have been provided which reduce operational burden on the user by distinguishing between operations which can be automated and operations which require user inputs, based on purposes of examination as well as on imaging conditions and the like and thereby controlling progress of the entire examination.

As mentioned above, with diversification of modality apparatus and diversification of imaging methods, applications used to process acquired medical image data have been diversified as well. For example, processing methods for medical image data acquired by a magnetic resonance imaging (MRI) apparatus include an image processing method known as diffusion tensor imaging (DTI), and an application for creating DTI images is provided. Similarly, applications are available including an application of functional MRI (fMRI) used to observe regional cerebral blood flow produced by brain activity, an application for generating three-dimensional images using a multiplanar reconstruction (MPR) method which involves acquiring arbitrary cross sections from three-dimensional image data or a rendering method which involves creating a projected display on a two-dimensional plane so as to give a three-dimensional appearance, a magnetic resonance spectroscopy (MRS) application capable of capturing chemical information in a living body using a frequency difference known as a chemical shift between MR signals, and an application based on an imaging method such as contrast radiography or cardiac-gated scanning.

In order to perform image processing using these applications, it is necessary to properly select medical image data available for use by the respective applications. DTI image is obtained by tensor analysis of a diffusion weighted image (DWI) with enhanced diffusion effect whereby particles such as water molecules in a nerve fiber scatter due to Brownian motion caused by heat. For example, a DWI can be acquired by an imaging method which applies a strong gradient magnetic field known as MPG (Motion Probing Gradient) pulses and thereby enhances a phase shift caused by movements of an imaged object. Also, in order to generate three-dimensional images using the MPR method which involves acquiring arbitrary cross sections from three-dimensional image data or using the rendering method, it is necessary to be compatible with a data format of a three-dimensional volume data obtained by a three-dimensional imaging technique or multi-slice imaging. In this way, the imaging method, format, and the like of image data to be processed varies with the type of application.

Also, one examination is made up of plural imaging protocols differing in the imaging method. One or more images are acquired based on one imaging protocol. Hereinafter, data made up of one or more images acquired based on one imaging protocol will be referred to as an image dataset. Thus, the data acquired by one examination (hereinafter referred to as examination data) is a collection of image datasets generated based on respective ones of plural imaging protocols. Therefore, when acquired examination data is subjected to image processing on a medical diagnostic imaging apparatus, it is necessary to select an application compatible with an image dataset selected from the plural image datasets making up the acquired examination data. To start an application, it is necessary to select an image dataset from an image selection screen which lists the plural image datasets and then select an application from an application selection screen which displays a list of applications. In so doing, if the selected image dataset is not available for use by the selected application, the application cannot be started successfully. This creates a task of searching for another application or a task of selecting another image dataset anew on a screen for use to confirm an image dataset.

In this way, it is difficult for the user to achieve a suitable combination by selecting an appropriate application from various applications for each of the plural image datasets acquired by plural imaging methods.

Thus, there is demand for a medical diagnostic imaging apparatus having a function to help select the right combinations of image datasets and applications.

### BRIEF DESCRIPTION OF THE DRAWINGS

In the accompanying drawings:

FIG. 1 is a conceptual configuration diagram showing an example of a medical diagnostic imaging apparatus according to the exemplary embodiment;

FIG. 2 is a functional block diagram showing a functional configuration example of the medical diagnostic imaging apparatus 1 according to the exemplary embodiment;

FIG. 3 is a diagram illustrating an examination and imaging protocols;

FIG. 4 is a diagram schematically illustrating examination data and image datasets;

FIG. 5 is a flowchart describing application startup on a conventional medical diagnostic imaging apparatus;

FIG. 6 is a diagram illustrating an image selection screen displayed on the conventional medical diagnostic imaging apparatus;

FIG. 7 is a diagram illustrating the application selection screen displayed on the conventional medical diagnostic imaging apparatus;

FIG. 8 is a flowchart showing the first embodiment of the medical diagnostic imaging apparatus according to the exemplary embodiment;

FIG. 9 is a diagram illustrating a display example of an image dataset list on the medical diagnostic imaging apparatus according to the exemplary embodiment;

FIG. 10 is a diagram illustrating an example of the adaptability assessment table of the medical diagnostic imaging apparatus according to the exemplary embodiment;

FIG. 11 is a diagram illustrating an example of the adaptive application list display section of the medical diagnostic imaging apparatus according to the exemplary embodiment;

FIG. 12 is a diagram illustrating a first display example of the application processing history display section on the medical diagnostic imaging apparatus according to the exemplary embodiment;

FIG. 13 is a diagram illustrating a second display example of the application processing history display section on the medical diagnostic imaging apparatus according to the exemplary embodiment;

FIG. 14 is a diagram illustrating resumption of image processing on the medical diagnostic imaging apparatus according to the exemplary embodiment;

FIG. 15 is a flowchart showing the second embodiment of the medical diagnostic imaging apparatus according to the present exemplary embodiment;

FIG. 16 is a diagram illustrating an example of the adaptive image dataset list display section of the medical diagnostic imaging apparatus according to the exemplary embodiment;

FIG. 17 is a diagram illustrating an example of the image dataset history display section of the medical diagnostic imaging apparatus according to the exemplary embodiment; and

FIG. 18 is a conceptual configuration diagram showing an example of the medical image display apparatus according to the exemplary embodiment.

### DETAILED DESCRIPTION

To solve the above-described problems, a medical diagnostic imaging apparatus according to the present embodiment includes: an execution unit configured to execute a plurality of imaging protocols included in an examination; and a display control unit configured to display a first screen and a second screen, where the first screen selectably displays a plurality of image datasets collected based on the respective imaging protocols after execution of the plurality of imaging protocols as well as extracts and displays postprocessing applications applicable to individual ones of the image datasets while the second screen is brought up by transitioning from the first screen and used to perform postprocessing of the image datasets, wherein when an application associated with a predetermined image dataset is selected on the first screen, the display control unit starts the selected application and transitions from the first screen to the second screen to perform postprocessing of the predetermined image dataset.

A medical diagnostic imaging apparatus, medical image display apparatus, and medical image display method according to an exemplary embodiment of the present invention will be described with reference to the accompanying drawings.

### (1) Configuration

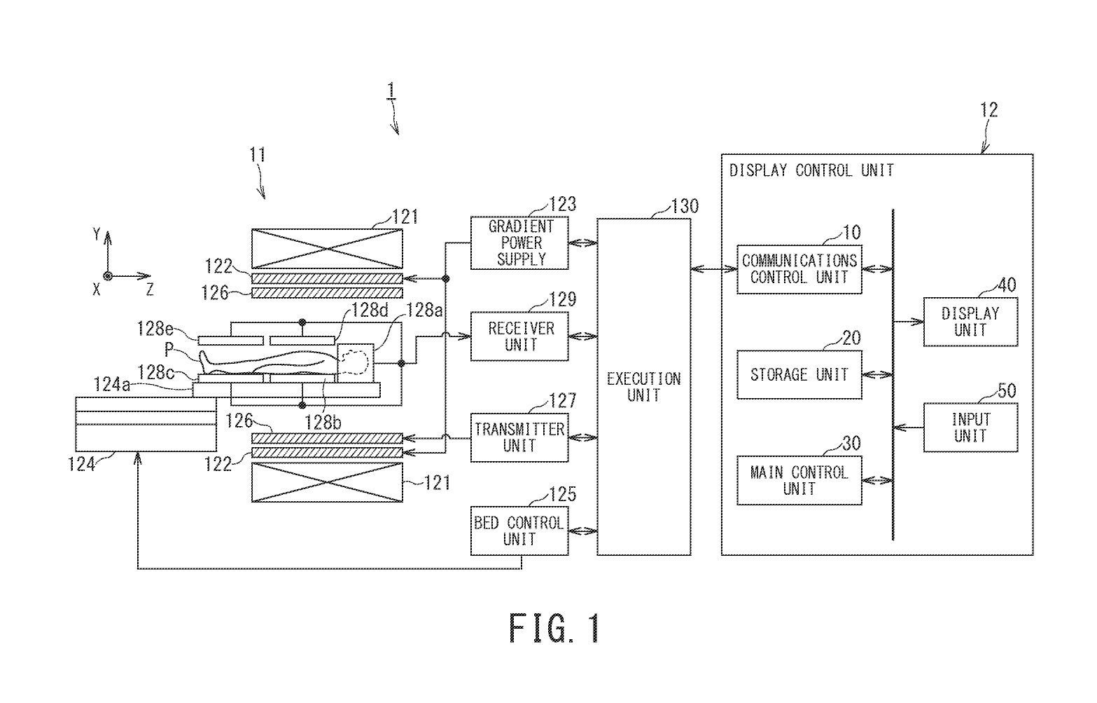

FIG. 1 is a conceptual configuration diagram showing an example of a medical diagnostic imaging apparatus 1 according to the exemplary embodiment. In the example of FIG. 1, it is assumed that the medical diagnostic imaging apparatus 1 is an MRI apparatus. The medical diagnostic imaging apparatus 1 according to the present exemplary embodiment is not limited to the MRI apparatus, and may be another modality apparatus such as an X-ray CT (Computed Tomography) apparatus, SPECT (Single Photon Emission computed Tomography) apparatus or PET (Positron Emission computed Tomography) apparatus. As shown in FIG. 1, the medical diagnostic imaging apparatus 1 includes an imaging system 11 and a display control unit 12.

The imaging system 11 includes a static magnet 121, a gradient coil 122, a gradient power supply 123, a bed 124, a bed control unit 125, a transmitter coil 126, a transmitter unit 127, receiver coils 128a to 128e, a receiver unit 129, and an execution unit (sequence controller) 130.

The static magnet 121 is formed into a hollow cylindrical shape in outermost part of a gantry (not shown) and configured to generate a uniform static magnetic field in an internal space. As the static magnet 121, a permanent magnet or superconductive magnet is used, for example.

The gradient coil 122 is formed into a hollow cylindrical shape and is placed on an inner side of the static magnet 121. The gradient coil 122 is made up of a combination of coils which correspond, respectively, to X, Y, Z axes orthogonal to one another. Being supplied with electric currents individually from the gradient power supply 123, the three coils generate gradient magnetic fields whose magnetic field intensity change along the X, Y, Z axes, respectively. Note that the Z axis coincides in direction with the static magnetic field. The gradient power supply 123 supplies an electric current to the gradient coil 122 based on pulse sequence execution data sent from the execution unit 130.

The gradient magnetic fields generated by the gradient coil 122 include a readout gradient magnetic field Gr, a phase encoding gradient magnetic field Ge, and a slice selection gradient magnetic field Gs. The readout gradient magnetic field Gr is used to change a frequency of an MR signal according to spatial position. The phase encoding gradient magnetic field Ge is used to change a phase of the MR signal according to the spatial position. The slice selection gradient magnetic field Gs is used to determine an imaging section as desired. For example, in order to acquire a slice of an axial section, the X, Y, Z axes shown in FIG. 1 are brought into correspondence with the readout gradient magnetic field Gr, phase encoding gradient magnetic field Ge, and slice selection gradient magnetic field Gs, respectively.

The bed 124 includes a table top 124a on which a patient P is mounted. The bed 124 inserts the table top 124a with the patient P mounted thereon into a cavity (imaging port) of the gradient coil 122 under the control of the bed control unit 125 described later. Normally, the bed 124 is installed such that a longitudinal direction thereof will be parallel to a center axis of the static magnet 121.

The bed control unit 125 moves the table top 124a in longitudinal and vertical directions by driving the bed 124 under the control of the execution unit 130.

The transmitter coil 126, which is placed on an inner side of the gradient coil 122, generates an RF magnetic field by being supplied with a radio-frequency (RF) signal from the transmitter unit 127. The transmitter coil 126, which is also called a whole body RF coil, is also used as a receiver coil.

The transmitter unit 127 transmits an RF signal corresponding to Larmor frequency to the transmitter coil 126 based on the pulse sequence execution data sent from the execution unit 130.

The receiver coils 128a to 128e, which are placed on the inner side of the gradient coil 122, receive MR signals emitted from the patient P in response to the RF signal. Each of the receiver coils 128a to 128e is an array coil made up of plural coil elements which receive the respective MR signals emitted from the patient P and outputs the received MR signals to the receiver unit 129 when the MR signals are received by respective coil elements.

The receiver coil 128a is a head coil mounted around the head of patient P. Also, the receiver coils 128b and 128c are spine coils placed between the spine of the patient P and the table top 124a. Also, the receiver coils 128d and 128e are abdominal coils mounted above the abdomen of the patient P. Also, the medical diagnostic imaging apparatus 1 may be equipped with a combined transmitter-receiver coil.

The receiver unit 129 generates MR signal data based on the pulse sequence execution data sent from the execution unit 130 as well as on the MR signals outputted from the receiver coils 128a to 128e. Also, upon generating the MR signal data, the receiver unit 129 transmits the MR signal data to the display control unit 12 via the execution unit 130.

Note that the receiver unit 129 has plural receiver channels to receive the MR signals outputted from the plural coil elements of the receiver coils 128a to 128e. When informed by the display control unit 12 about the coil elements used for imaging, the receiver unit 129 assigns receiver channels to the coil elements the receiver unit 129 is informed of, so as to receive the MR signals outputted from the coil elements the receiver unit 129 is informed of.

The execution unit 130 is connected with the gradient power supply 123, bed control unit 125, transmitter unit 127, receiver unit 129, and display control unit 12. The execution unit 130 includes a processor (not shown) such as a CPU (central processing unit) and memory, and stores control information needed to drive the gradient power supply 123, bed control unit 125, transmitter unit 127, and receiver unit 129, including, for example, sequence information describing operational control information such as intensity, application duration, and application timing of a pulsed current to be applied to the gradient power supply 123.

Also, the execution unit 130 executes plural imaging protocols included in an examination. The execution unit 130 drives the gradient power supply 123, transmitter unit 127, and receiver unit 129 according to stored predetermined sequence information and thereby generates X-axis gradient magnetic field Gx, Y-axis gradient magnetic field Gy, and Z-axis gradient magnetic field Gz as well as HF signals in the gantry. Furthermore, the execution unit 130 drives the bed control unit 125 according to stored predetermined sequence information and thereby moves the table top 124a forward and backward in a Z direction with respect to the gantry.

The display control unit 12 displays a first screen and second screen, where the first screen selectably displays plural image datasets collected based on the respective imaging protocols after execution of the plural imaging protocols as well as extracts and displays postprocessing applications applicable to individual image datasets while the second screen is brought up by transitioning from the first screen and used to perform postprocessing of the image datasets. Also, in addition to display control of image datasets such as described above, the display control unit 12 performs overall control of the medical diagnostic imaging apparatus 1, data collection, image reconstruction, and so on. The display control unit 12 includes a communications control unit 10, a storage unit 20, a main control unit 30, a display unit 40, and an input unit 50.

The communications control unit 10 is connected to the gradient power supply 123, bed control unit 125, transmitter unit 127, and receiver unit 129 of the imaging system 11 via the execution unit 130 and adapted to control input and output of signals exchanged between the connected components and the display control unit 12.

The MR signal data received from the receiver unit 129 is stored in the storage unit 20 via the communications control unit 10. By performing postprocessing of the MR signal data stored in the storage unit 20, spectrum data or an image dataset of a desired nuclear spin in the patient P is generated. Applications for use to postprocess the acquired MR signals are available in various types according to the imaging methods such as DWI, MPR, MRS, and fMRI. Such applications run when a program stored in the storage unit 20 is executed by the main control unit 30.

The storage unit 20 stores collected MR signal data, generated image datasets, or plural applications.

As a program stored in the storage unit 20 is executed by the main control unit 30, acquired examination data and applications are selected.

The storage unit 20, which is made up of storage media such as a RAM and ROM, may be configured to include a storage medium, such as a magnetic or optical storage medium or a semiconductor memory, readable by the main control unit 30 and download some or all of programs and data onto these storage media via an electronic network. Also, the applications used by the medical diagnostic imaging apparatus 1 may be prestored in the storage unit 20 or may be acquired from an external application server via the communications control unit 10.

The display unit 40, which is a typical display device such as a liquid crystal display or OLED (Organic Light Emitting Diode) display, displays images under the control of the main control unit 30.

The input unit 50 is made up of typical input devices such as a keyboard, touch panel, numerical keypad, and/or mouse. The input unit 50 outputs an input signal corresponding to a user action such as selection of an application or image dataset, interruption of an application, or the like to the main control unit 30.

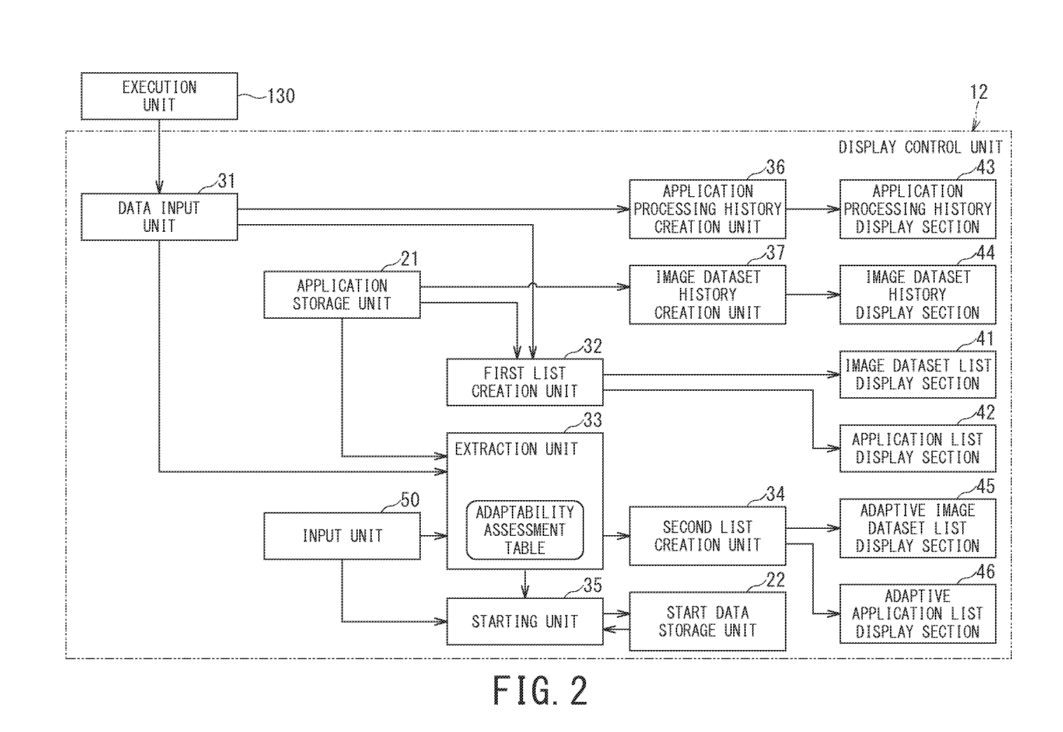

FIG. 2 is a functional block diagram showing a functional configuration example of the medical diagnostic imaging apparatus 1 according to the exemplary embodiment. As shown in FIG. 2, the display control unit 12 includes an application storage unit 21, a start data storage unit 22, a data input unit 31, a first list creation unit 32, an extraction unit 33, a second list creation unit 34, a starting unit 35, an application processing history creation unit 36, an image dataset history creation unit 37, an image dataset list display section 41, an application list display section 42, an application processing history display section 43, an image dataset history display section 44, an adaptive image dataset list display section 45, an adaptive application list display section 46, and an input unit 50. Of these, the data input unit 31, first list creation unit 32, extraction unit 33, second list creation unit 34, starting unit 35, application processing history creation unit 36, and image dataset history creation unit 37 are functions implemented when a program stored in the storage unit 20 is executed by the main control unit 30.

The application storage unit 21 stores image processing applications available for use on a medical diagnostic imaging apparatus 1.

The data input unit 31 acquires examination data from an imaging unit 11. The examination data includes patient information about the patient who is examined, a name of a modality apparatus used for the examination, and plural image datasets acquired based on plural imaging protocols of the examination. The examination data will be described later.

The first list creation unit 32 creates one of two types of list: a list of plural image datasets contained in the examination data and a list of plural applications available for use by the medical diagnostic imaging apparatus 1. The first list creation unit 32 creates a list of the plural image datasets making up the examination data when an Image Selection Screen is displayed on the medical diagnostic imaging apparatus 1, and creates a list of the plural applications available for use on the medical diagnostic imaging apparatus 1 when an Application Selection Screen is displayed.

The image dataset list display section 41 displays a list of plural image datasets, allowing one image dataset to be selected from the list of plural image datasets. The image dataset list display section 41 displays a list of the plural image datasets making up the examination data when the list is created by the first list creation unit 32. The list of image datasets created by the first list creation unit 32 will be described later.

The application list display section 42 displays a list of plural applications, allowing one application to be selected from the list of plural applications. The application list display section 42 displays a list of the applications available for use on the medical diagnostic imaging apparatus 1 as the list is created by the first list creation unit 32. The list created by the first list creation unit 32 and containing the applications available for use on the medical diagnostic imaging apparatus 1 will be described later.

From plural applications, the extraction unit 33 extracts one or more adaptive applications capable of processing one image dataset selected from image datasets. By comparing accompanying information on examination data with an adaptability assessment table stored in the application storage unit 21, the extraction unit 33 extracts items for a second list. The second list is created based on the plural image datasets contained in the examination data or applications available for use by the medical diagnostic imaging apparatus 1, whichever are not selected in creating a first list. That is, if the first list is a list of the plural image datasets contained in the examination data, the second list is created based on the applications available for use on the medical diagnostic imaging apparatus 1. On the other hand, if the first list is a list of the applications available for use on the medical diagnostic imaging apparatus 1, the second list is created based on the plural image datasets contained in the examination data. A method used by the extraction unit 33 to extract items for the second list using the adaptability assessment table will be described later.

The second list creation unit 34 creates the second list using the items extracted by the extraction unit 33. When image datasets are extracted by the extraction unit 33, a list of adaptive image datasets is created, and when applications are extracted, a list of adaptive applications is created.

The adaptive image dataset list display section 45 displays a list of one or more adaptive image datasets, allowing one adaptive image dataset to be selected from the list of one or more adaptive image datasets. The adaptive image dataset list display section 45 displays the list of adaptive image datasets, which is a second list created by the second list creation unit 34.

The adaptive application list display section 46 displays a list of one or more adaptive applications, allowing one adaptive application to be selected from the list of one or more adaptive applications. The adaptive application list display section 46 displays the list of adaptive applications, which is a second list created by the second list creation unit 34.

Based on input from the input unit 50 and the like, the starting unit 35 starts an image processing application using a combination of the image dataset and application selected from the first list and second list.

The start data storage unit 22 stores a combination of an application and an image dataset, the combination being used to start the application when image processing by the application is interrupted. Besides, the start data storage unit 22 also stores start data generated when the application is started. The start data will be described later.

The application processing history creation unit 36 creates an application processing history. The application processing history creation unit 36 creates a display image related to a usage history of applications used for an image dataset. The application processing history creation unit 36 creates the display image of the application processing history based on the application processing history contained in the accompanying information on each image dataset.

The application processing history display section 43 displays the application processing history. The application processing history display section 43 displays the display image of the application processing history created by the application processing history creation unit 36.

The image dataset history creation unit 37 creates a usage history of image datasets, based on a history of the image datasets processed by each application.

The image dataset history display section 44 displays the image dataset history. The image dataset history display section 44 displays a display image of the image dataset history created by the image dataset history creation unit 37.

### (2) Operation

First, the examination data and image datasets used by the medical diagnostic imaging apparatus 1 will be described.

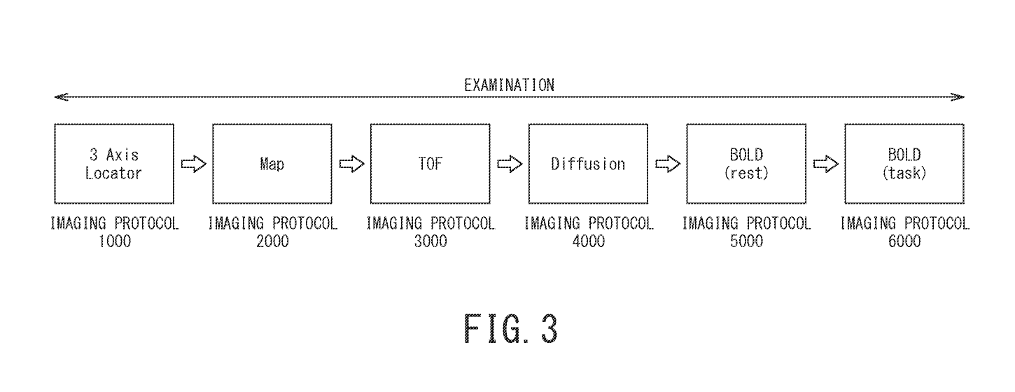

FIG. 3 is a diagram illustrating an examination and imaging protocols. As shown in FIG. 3, one examination is made up of plural imaging protocols. FIG. 3 shows an example in which one examination is made up of six imaging protocols.

The examination shown in the example of FIG. 3 is made up of six imaging protocols which, in order from left to right, are: “3 Axis Locator” (imaging protocol 1000) which involves carrying out imaging to acquire one positioning image each in an X-direction, Y-direction, and Z-direction, “Map” (imaging protocol 2000) which involves carrying out imaging to acquire a sensitivity map of a receiving coil, “TOF” (imaging protocol 3000) which involves carrying out imaging by a TOF (Time of Flight) method, “Diffusion” (imaging protocol 4000) which involves carrying out imaging to obtain a diffusion tensor image by applying a strong gradient magnetic field known as MPG (Motion Probing Gradient) pulses and thereby enhancing a phase shift caused by movements of an imaged object, and “BOLD” (imaging protocols 5000 and 6000) which involves carrying out imaging by a BOLD (Blood Oxygenation Level Dependent) method to observe changes in regional cerebral blood flow produced by brain activity, where the BOLD method detects increases in oxygenated hemoglobin in a relative sense. Imaging protocols 5000 and 6000 involve carrying out imaging under two conditions, respectively, to compare a “rest” condition in which the patient is resting and a “task” condition in which the patient is engaged in some task.

In this way, one examination is made up of plural imaging protocols, which differ from one another in the imaging method, and the like.

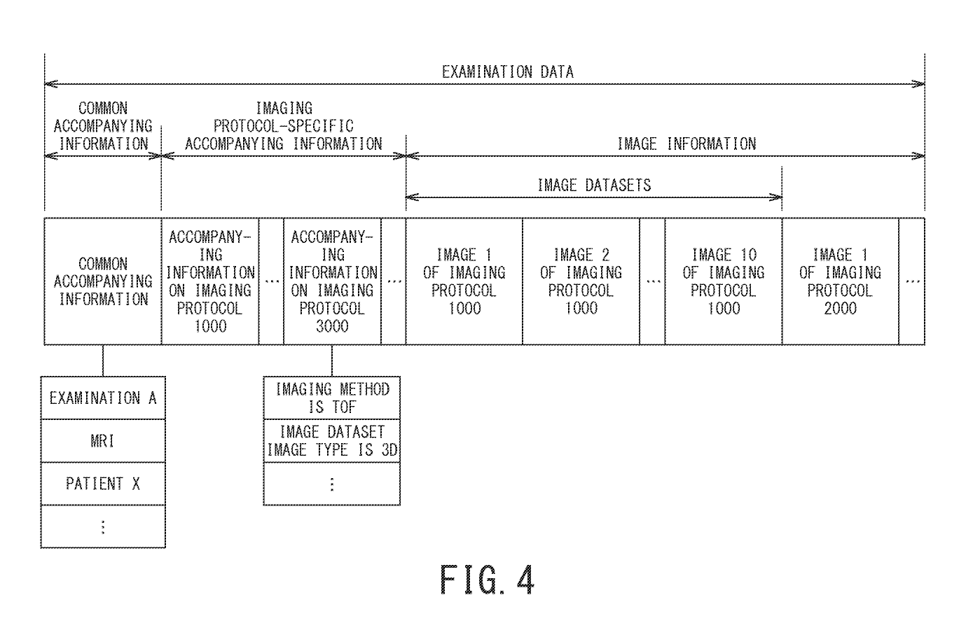

FIG. 4 is a diagram schematically illustrating examination data and image datasets. The examination data shown in FIG. 4 is an example obtained when the examination shown in FIG. 3 is conducted.

The examination data shown in FIG. 4 is made up of common accompanying information, imaging protocol-specific accompanying information, and image information in order from left to right. The data acquired by the medical diagnostic imaging apparatus 1 is accompanied by information about an imaging condition, an examination type, and the like in addition to the image datasets. The data acquired by the medical diagnostic imaging apparatus 1 conforms, for example, to the DICOM (Digital Imaging and COmmunication in Medicine) standard. DICOM is a global standard which allows data acquired by different medical diagnostic imaging apparatus 1 to be handled by standardized data formats and communications methods.

The common accompanying information contains information common to plural imaging protocols making up the examination data. Specifically, as shown under the common accompanying information in FIG. 4, the common accompanying information contains an examination name (examination A), a modality type (MRI) used for the examination, and patient information about the patient (patient X).

When the examination shown in FIG. 3 is conducted, an image dataset including plural images is generated in relation to each imaging protocol executed. Each imaging protocol varies in imaging parameters including imaging method, type of generated image, and imaging condition. This information is stored in the imaging protocol-specific accompanying information. As shown under the accompanying information on imaging protocol 3000 in FIG. 4, imaging protocol 3000 is a three-dimensional image made up of plural successive slice images whose imaging method is “TOF” and whose image dataset image type is “3D.”

The image information shown after the imaging protocol-specific accompanying information in FIG. 4 exists for each imaging protocol. For example, imaging protocol-specific accompanying information exists for each of the imaging protocols from imaging protocol 1000 to imaging protocol 6000 shown in FIG. 4. Accordingly, an image dataset is generated for each imaging protocol. That is, an image dataset exists for each of the imaging protocols from imaging protocol 1000 to imaging protocol 6000.

### (Conventional Embodiment)

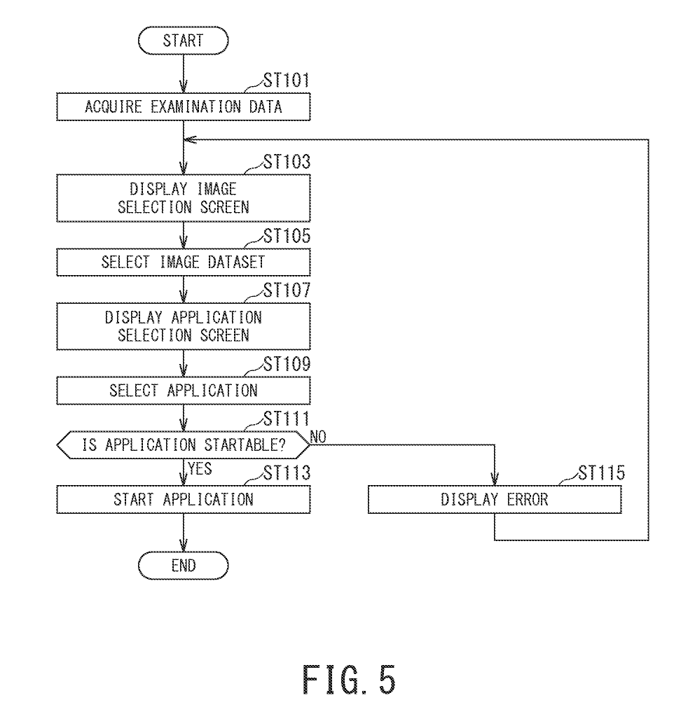

FIG. 5 is a flowchart describing application startup on a conventional medical diagnostic imaging apparatus.

In ST101, the examination data described in FIG. 4 is acquired by a conventional medical diagnostic imaging apparatus.

In ST103, once the examination data described above is acquired, image datasets are displayed on an image selection screen.

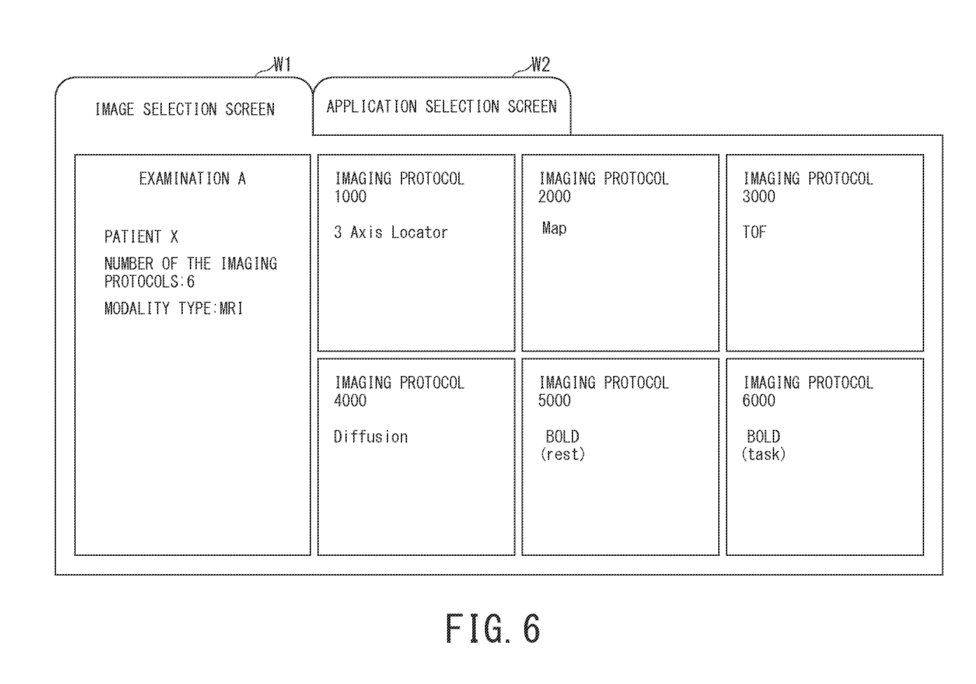

FIG. 6 is a diagram illustrating an image selection screen displayed on the conventional medical diagnostic imaging apparatus. FIG. 6 shows an example of an image selection screen W1 of the conventional medical diagnostic imaging apparatus. In the example shown in FIG. 6, Image Selection Screen and Application Selection Screen are displayed switchably in tab display format. When the tab of Application Selection Screen is pressed, an application selection screen W2 is brought up. Although in the example of FIG. 6, the display is switched by tabs, a button may be displayed to switch between Image Selection Screen and Application Selection Screen.

When the examination illustrated by example in FIG. 4 is conducted, an image dataset is generated for each of the six imaging protocols. Each of six screen segments on the right of the image selection screen W1 shown in the example of FIG. 6 displays an image of an image dataset of the examination data and a character string describing an imaging protocol. The images displayed in the six frame segments are an image of “3 Axis Locator” (imaging protocol 1000), an image of “Map” (imaging protocol 2000), an image of TOF (imaging protocol 3000) in order from upper left to upper right; and an image of “Diffusion” (imaging protocol 4000), an image of “BOLD (rest)” (imaging protocol 5000), and an image of “BOLD (task)” (imaging protocol 6000) in order from lower left to lower right. Also, as shown in FIG. 6, the frame in which the image dataset of each imaging protocol is displayed also presents an imaging protocol number for use to identify the displayed image and a character string describing the imaging method.

Also, the left side of the image selection screen W1 in FIG. 6 displays the patient information and modality type contained in the common accompanying information on the examination data. Since the examination shown in FIG. 4 has been conducted using an MRI apparatus, “MRI” is indicated as the modality used.

In ST105 of FIG. 5, an image dataset is selected on the image selection screen W1. Based on the display shown in FIG. 6, the user selects an image dataset from images of image datasets and character strings describing imaging protocols, using an input unit 50 made up of a mouse and keyboard.

In ST107, the image selection screen W1 transitions to the application selection screen W2, bringing up the application selection screen W2. The screen transition from the image selection screen W1 to the application selection screen W2 takes place as a tab or button of Application Selection Screen displayed on the image selection screen W1 is pressed by the user via an input unit 50.

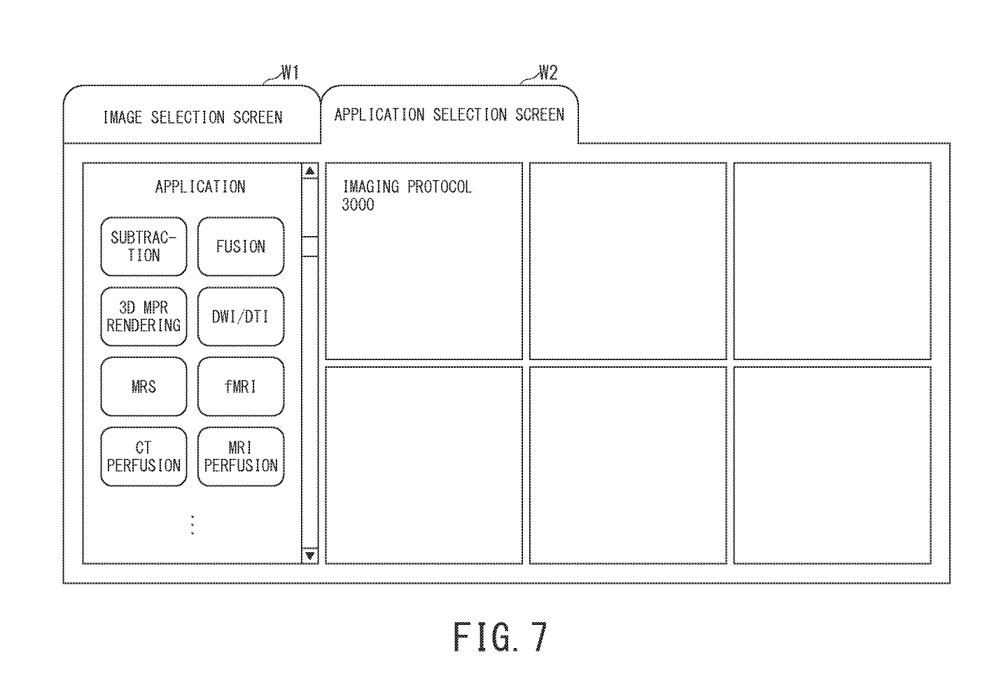

FIG. 7 is a diagram illustrating the application selection screen W2 displayed on the conventional medical diagnostic imaging apparatus. FIG. 7 shows an example of the application selection screen W2 of the conventional medical diagnostic imaging apparatus. As with the example of FIG. 6, in FIG. 7, Image Selection Screen and Application Selection Screen are displayed switchably in tab display format. FIG. 7 shows an example of a display after an image dataset of imaging protocol 3000 is selected on the image selection screen W 1 of FIG. 6 and a transition to the application selection screen W2 takes place.

A list of applications is shown on the left side of FIG. 7. A “subtraction” application displayed on the upper left of the application list is an application which performs image processing to compare images obtained from a same site and differing in time phase and exclude a structure common to the images. For example, in comparing images before and after angiography, a subtraction process allows only an angiographic signal to be picked up by excluding unnecessary tissues such as bones. Also a “fusion” application shown to the right is designed to perform image processing to display superimposed images. With PET, it is difficult to acquire morphological information on organs and the like. Thus, an image is sometimes observed by being superimposed with an image acquired by another modality apparatus such as an X-ray CT apparatus or MRI apparatus capable of acquiring morphological information. Similarly, a “3D MPR rendering” application displayed to the lower left is used to generate a three-dimensional image by an MPR method or rendering method, where the MPR method is designed to acquire arbitrary cross sections from a three-dimensional image dataset. A “DWI/DTI” application is used to acquire a diffusion tensor image. An “MRS” application is designed to image MR sensitivity of a target nuclide as well as abundance of the nuclide in a living body. An “fMRI” application is used to observe regional cerebral blood flow produced by brain activity. “CT perfusion” and “MRI perfusion” applications are designed to analyze blood flow using images obtained by an X-ray CT apparatus and MRI apparatus, respectively.

In addition to the applications described above, the applications shown on the left side of FIG. 7 include various image processing applications specialized in an anatomical region or imaging method, such as an application for analyzing a cardiac-gated scan.

In ST109 of FIG. 5, an application is selected on the application selection screen W2.

In ST111, it is determined whether the application selected on the application selection screen W2 can be started for the image dataset selected on the image selection screen W1. If the application can be started, the application starts in ST113, starting image processing. On the other hand, if it is determined in ST111 that the combination of the image dataset and application is incompatible, an error results as shown in ST115 and the application does not start.

An image of imaging protocol 3000 selected on the image selection screen W1 of FIG. 6 is displayed on the right side of FIG. 7. As information describing the image of imaging protocol 3000, the imaging protocol number and a character string “TOF” describing the imaging method are displayed. With the conventional medical diagnostic imaging apparatus, an application displayed on the left side of FIG. 7 needs to be selected, based on information about the imaging protocol including the displayed character string describing the imaging method.

For example, if the “fMRI” application is selected in the example of FIG. 7, the application does not start. Because of a difference in the imaging method, fMRI, which uses the BOLD method to analyze an amount of oxygenated hemoglobin changing with brain activity, cannot be used for the image dataset of imaging protocol 3000 acquired by the TOF method. In this way, depending on the difference in the imaging method and the like, there are applications available for use and applications unavailable for use. At startup of each selected application, the conventional medical diagnostic imaging apparatus determines whether an image dataset selected earlier can be used on the application.

As described above, with the conventional medical diagnostic imaging apparatus, since image datasets and applications are selected freely by the user, an incompatible combination of an image dataset and application could be selected. In that case, the application does not start successfully, and with the conventional medical diagnostic imaging apparatus, it is necessary to select image dataset and application from the beginning by returning to ST103.

Furthermore, the conventional medical diagnostic imaging apparatus includes the image selection screen W1 used to select an image dataset and the application selection screen W2 used to select an application, making it necessary to select an image dataset and application separately on the respective screens. Consequently, if a combination of an image dataset and application is incompatible, the application does not start up, and it is necessary to make selections anew by returning to the respective screens.

Also, plural imaging protocols are executed in one examination, and plural image datasets are acquired in relation to each imaging protocol. Also, different imaging methods are used for different imaging protocols and the image datasets available for use vary from application to application. Also, since the information which can be displayed on the image selection screen W1 including imaging conditions for image datasets is part of information contained in the accompanying information, the user has to select an application based on limited information.

Thus, the present invention provides the medical diagnostic imaging apparatus 1 which assists user selection by creating a list of applications and a list of image datasets based on either the applications or image datasets whichever are selected.

In selecting the image datasets and applications, an embodiment in which the image datasets are selected first will be referred to herein as a “first embodiment” and an embodiment in which the applications are selected first will be referred to as a “second embodiment” and these embodiments will be described below.

### First Embodiment

The first embodiment involves selecting image datasets first.

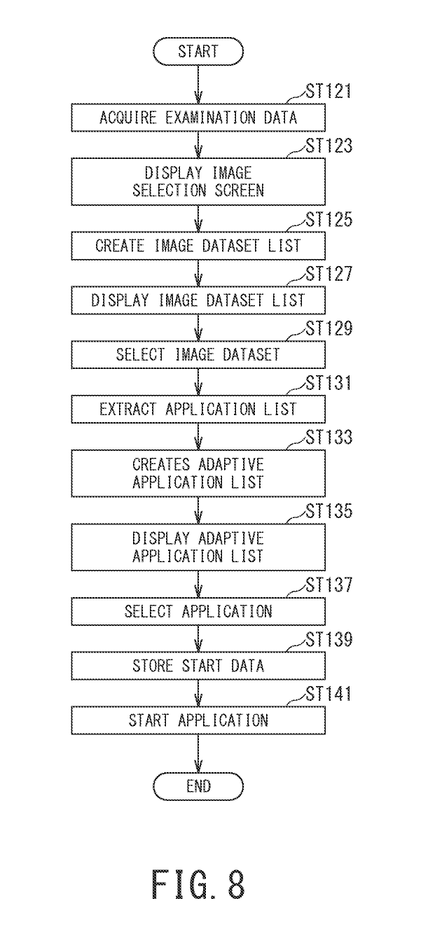

FIG. 8 is a flowchart showing the first embodiment of the medical diagnostic imaging apparatus 1 according to the exemplary embodiment.

In ST121, examination data is inputted to the data input unit 31. Via the execution unit 130, the data input unit 31 acquires the MR signals collected by the imaging unit 11. The examination data acquired by the data input unit 31 is, for example, data in a format shown in FIG. 4, and includes accompanying information in addition to images.

In ST123, the image selection screen W1 is displayed in order for the user to use examination data.

In ST125, since the displayed screen is the image selection screen W1, the first list creation unit 32 creates a list of image datasets as a first list. The list of image datasets lists all the image datasets contained in the acquired examination data.

In ST127, the list of image datasets created by the first list creation unit 32 is displayed in the image dataset list display section 41.

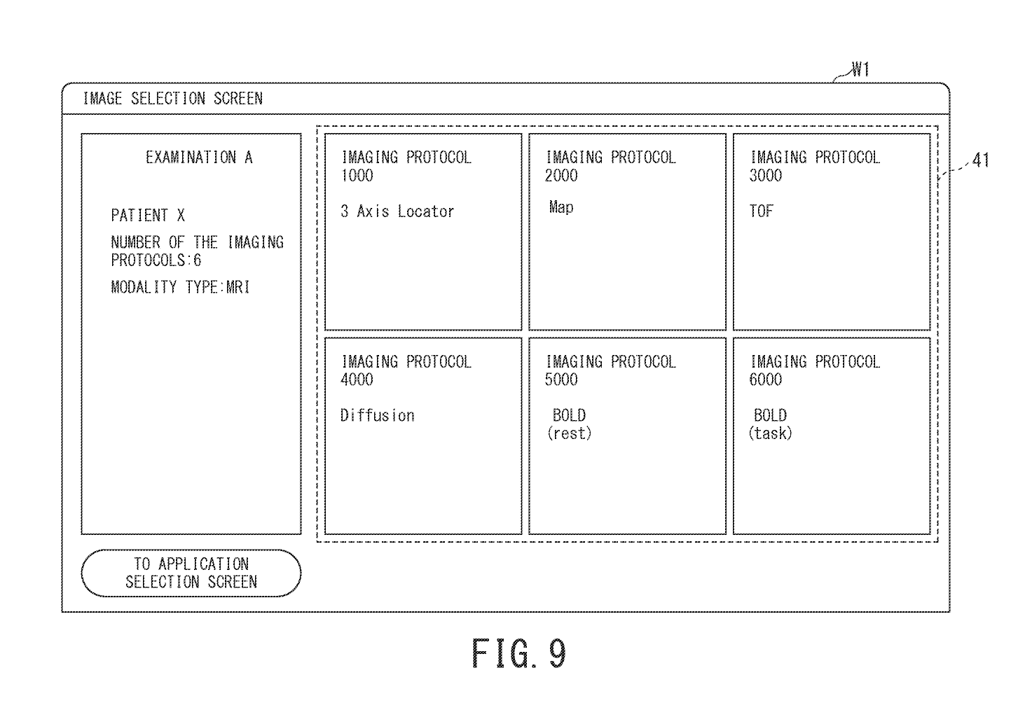

FIG. 9 is a diagram illustrating a display example of an image dataset list on the medical diagnostic imaging apparatus 1 according to the exemplary embodiment. FIG. 9 shows an example in which the image selection screen W1 shown in tab format in FIG. 6 is displayed as a single screen. A To Application Selection Screen button is provided in the lower left of FIG. 9, allowing transition to the application selection screen W2.

The left side of the image selection screen W1 in FIG. 9 displays the examination name and modality type contained in the common accompanying information on the examination data as in the case of FIG. 6.

The right side of the image selection screen W1 in FIG. 9 is the image dataset list display section 41. The image dataset list display section 41 displays a list of image datasets. The list of image datasets lists all the image datasets contained in the examination data. In the example of FIG. 9, individual datasets in the list are displayed in respective frames obtained by dividing the image dataset list display section 41 into six parts. Each frame displays an image acquired by one imaging protocol as well as character strings describing the imaging protocol number and an imaging condition. For example, an image based on imaging protocol 1000 (3 Axis locator) is displayed in the upper left frame of the image dataset list display section 41, and character strings “imaging protocol 1000” and “3 Axis locator” describing the image are displayed as well.

In ST129 of FIG. 8, based on the display in the image dataset list display section 41, the user selects an image dataset and the selected information is transmitted to the extraction unit 33 through the input unit 50.

In ST131, the extraction unit 33 extracts applications capable of processing the selected image dataset from all the applications stored in the application storage unit 21.

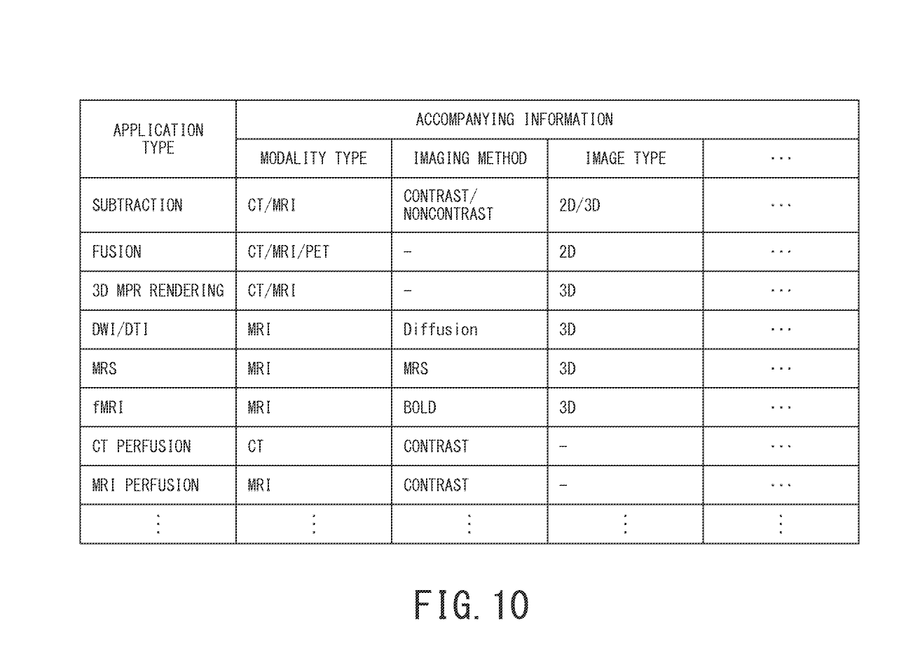

FIG. 10 is a diagram illustrating an example of the adaptability assessment table of the medical diagnostic imaging apparatus 1 according to the exemplary embodiment. As shown in FIG. 10, for each application type, the adaptability assessment table prescribes relations with at least “modality type,” “imaging method,” and “image type” of the accompanying information on the image dataset as conditions for starting the application. All or none of the conditions of the accompanying information may be set for each application. An application for which no determination condition is set supports all image datasets.

“Modality type” in the adaptability assessment table indicates the type of modality, such as X-ray CT apparatus (CT), MRI apparatus (MRI), or PET, which generates image datasets available for use by the application. “Imaging method” corresponds to the imaging method, such as the TOF method and BOLD method, selected according to a purpose of examination and indicates for which imaging method the application performs image processing. “Image type” indicates the type of supported image, such as a two-dimensional image (2D) and three-dimensional image (3D). Besides, the adaptability assessment table may prescribe “imaging parameters” and the like, which in turn prescribe imaging conditions such as “number of slices,” “slice direction,” and the like.

In the example of FIG. 10, the “modality type” of the “subtraction” application is “CT/MRI,” meaning that the application can handle image datasets acquired by any of an X-ray CT apparatus and MRI apparatus. It is indicated that “imaging method” is “contrast/noncontract,” meaning that imaging may or may not involve injection of a contrast medium into the patient. “Image type” is “2D/3D,” meaning that both two-dimensional images and three-dimensional images are supported. Also, in the case of the “fusion” application, “modality type” is “CT/MRI/PET,” meaning that the application can handle image datasets acquired by any of an X-ray CT apparatus, MRI apparatus, and PET. “Imaging method” is marked by “-,” meaning that the imaging method does not affect image processing by the application. “Image type” is “2D,” meaning that two-dimensional images are supported. Similarly, in the case of the “3D MPR rendering” application, “modality type” is “CT/MRI,” meaning that the application can handle image datasets acquired by any of an X-ray CT apparatus and MRI apparatus. “Imaging method” is marked by “-,” meaning that the imaging method does not affect image processing by the application. “Image type” is “3D.” In this way, depending on the application, image processing may be limited by the image type. In the case of the “DWI/DTI” application, “modality type” is “MRI,” meaning that the application can use only image datasets acquired by an MRI apparatus. Also, “imaging method” is “Diffusion” and “image type” is “3D.” In the case of the “MRS” application, “modality type” is “MRI,” meaning that the application can process image datasets acquired by an MRI apparatus. Also, “imaging method” is “MRS,” meaning that the application can process image datasets acquired by using a frequency difference known as a chemical shift between MR signals. Also, “image type” is “3D.” In the case of the “fMRI” application, “modality type” is “MRI,” meaning that the application can process image datasets acquired by an MRI apparatus. Also, “imaging method” is “BOLD,” meaning that the application can process image datasets acquired by an imaging method which allows observation of increases and decreases in oxygenated hemoglobin. Also, “image type” is “3D.” In the case of the “CT perfusion” application, “modality type” is “CT,” meaning that the application can process image datasets acquired by an X-ray CT apparatus. On the other hand, in the case of the “MRI perfusion” application, “modality type” is “MRI,” meaning that the application can process image datasets acquired by an MRI apparatus. The “imaging method” of “CT perfusion” and “MRI perfusion” is “contrast,” meaning that imaging involves injection of a contrast medium into the patient.

The adaptability assessment table illustrated by example in FIG. 10 prescribes essential determination conditions which must be complied with, but any desired determination conditions may also be prescribed. Conversely, a condition which disables any image dataset provided therewith from starting may be prescribed. The adaptability assessment table shown in FIG. 10 is an example of a table which is common to various modality apparatus, but an adaptability assessment table may be provided for each medical diagnostic imaging apparatus used.

The extraction unit 33 acquires “imaging method” and “image type” from the individual accompanying information on the selected image dataset and acquires “modality type” from the common accompanying information on the examination data to which the image dataset belongs. Then, based on the adaptability assessment table, an application capable of processing the selected image dataset is extracted.

In ST133 of FIG. 8, the second list creation unit 34 creates a list of adaptive applications as a second list based on the applications extracted by the extraction unit 33.

In ST135, since the list created by the second list creation unit 34 is a list of adaptive applications, the list is displayed in the adaptive application list display section 46.

In this way, according to the first embodiment, one image dataset is selected first from all the image datasets contained in the examination data. The extraction unit 33 extracts a list of applications capable of processing the selected image dataset from the applications stored in the application storage unit 21. Then, based on the extracted applications, the second list creation unit 34 creates and displays a list of adaptive applications.

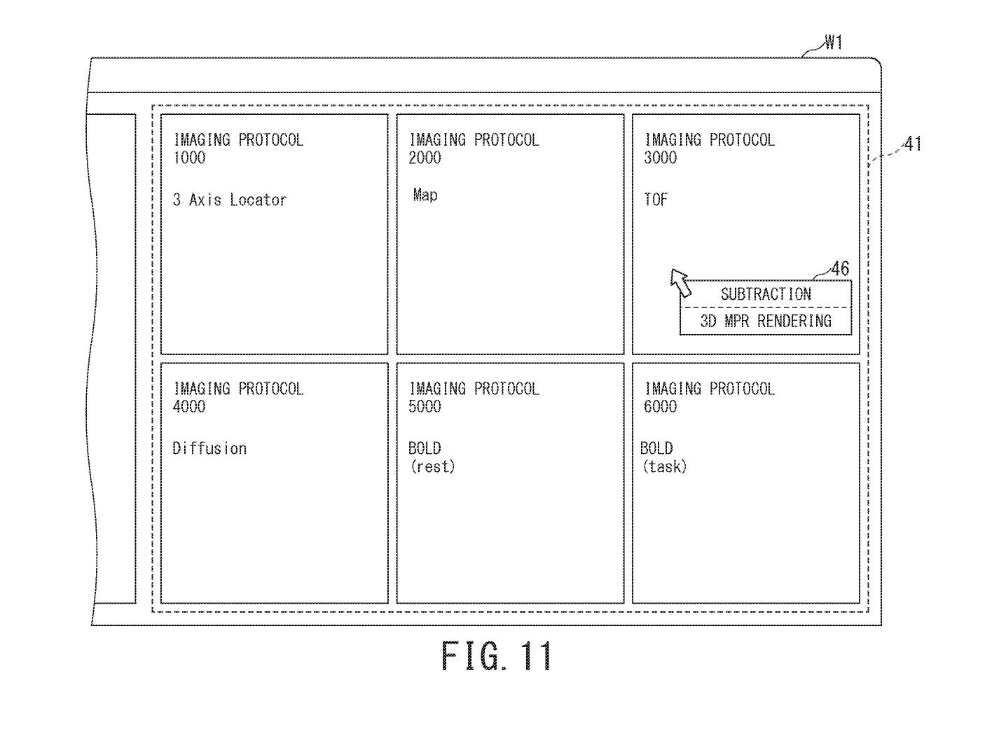

FIG. 11 is a diagram illustrating an example of the adaptive application list display section 46 of the medical diagnostic imaging apparatus 1 according to the exemplary embodiment. FIG. 11 shows part of the image selection screen W1 shown in FIG. 9. In FIG. 11, as in the case of FIG. 9, a list of image datasets is displayed in the image dataset list display section 41 on the right side of the image selection screen W1, and in the example shown in FIG. 11, imaging protocol 3000 is selected. Information that the image dataset of imaging protocol 3000 has been selected is acquired and transmitted to the extraction unit 33, for example, when an input operation such as a press on a display location of an imaging protocol image of imaging protocol 3000 is performed via the input unit 50.

As illustrated by example in FIG. 4, it is assumed that the image dataset of imaging protocol 3000 contains individual accompanying information which specifies that “imaging method” is “TOF” and that “image type” is “3D.” Furthermore, it is assumed that the common accompanying information on the examination data to which imaging protocol 3000 belongs contains “MRI” as “modality type.” Under these conditions, the extraction unit 33 extracts two types of applications—“subtraction” and “3D MPR/rendering”—from the application storage unit 21 based on the adaptability assessment table shown in FIG. 10.

A list of adaptive applications is created from the extracted applications by the second list creation unit 34 and displayed in the adaptive application list display section 46. As shown in FIG. 11, the list of adaptive applications lists two applications: “subtraction” and “3D MPR/rendering.” The list of adaptive applications is displayed in the adaptive application list display section 46 on imaging protocol 3000 selected. Also, the adaptive application display section 46 may be popped up on the image selection screen.

In ST137 of FIG. 8, one application is selected by the user from the list of adaptive applications displayed in the adaptive application display section 46. Information about the selected application is transmitted to the starting unit 35 via the input unit 50.

In ST139, the starting unit 35 generates start data from the selected application and selected image dataset and stores the start data in the start data storage unit 22. The start data contains information about a combination of the image dataset selected from the list of image datasets and the application selected from the list of adaptive applications, where the list of image datasets is a first list while the list of adaptive applications is a second list. As in the case of other image datasets, the start data may be stored as part of the examination data or may be stored in the storage unit 20.

In ST141, the starting unit 35 starts an image processing application using the image dataset selected from the list of image datasets, i.e., the first list, and the application selected from the list of adaptive applications, i.e., the second list.

In this way, whereas conventionally an application cannot be started without transitioning from the image selection screen W1 to the application selection screen W2, in the first embodiment, an application can be started directly on the image selection screen W1 displayed first. Furthermore, since only the applications which can use the selected image dataset are configured to be selectable, applications which cannot use the selected image dataset are not selected, and thus it is possible to avoid errors during startup. This eliminates the need to switch between the image selection screen W1 and application selection screen W2 which is the case with the conventional medical diagnostic imaging apparatus, and thereby simplifies user operation.

As a variation of the first embodiment, description will be given of an example in which the application processing history display section 43 is displayed together with the list of adaptive applications displayed in the adaptive application display section 46. A display image of an application processing history is created by the application processing history creation unit 36 based on the application processing history contained in the accompanying information on the image dataset, where the application processing history concerns the applications used in the past. The application processing history display section 43 displays the applications which have ever processed the selected image dataset.

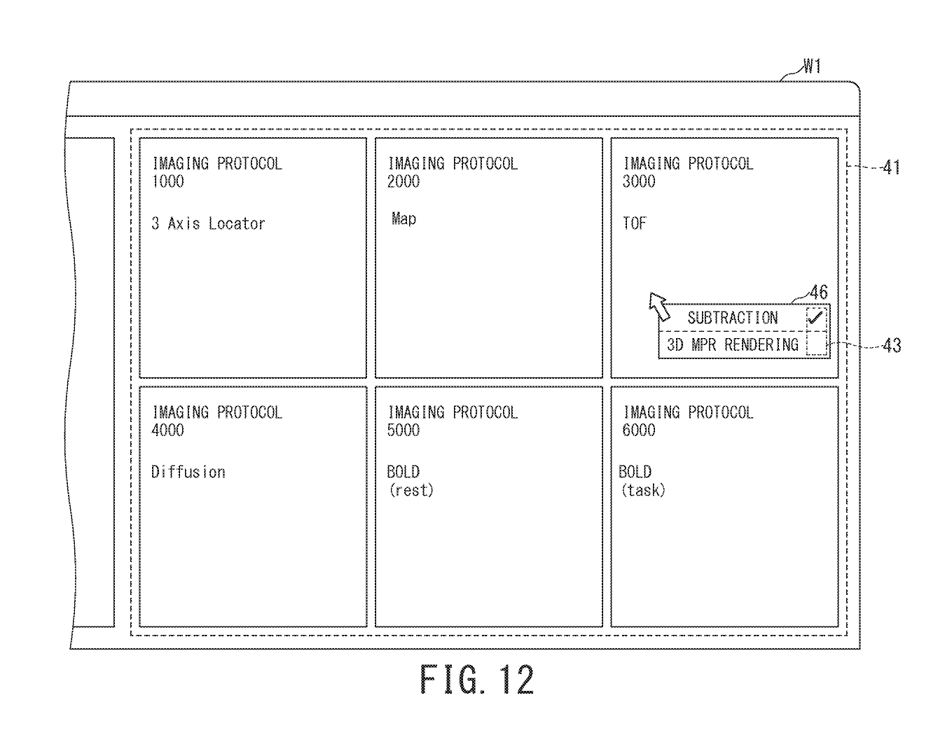

FIG. 12 is a diagram illustrating a first display example of the application processing history display section 43 on the medical diagnostic imaging apparatus 1 according to the exemplary embodiment. As with FIG. 11, FIG. 12 shows part of the image selection screen W1 shown in FIG. 9. Furthermore, in the example of FIG. 12, the image dataset of imaging protocol 3000 has been selected as in the case of FIG. 11. Also, a list of adaptive applications compatible with the image dataset of imaging protocol 3000 is displayed as in the case of FIG. 11. A difference from FIG. 11 lies in that the application processing history display section 43 displayed on a side of the adaptive application list contains a checkmark. The checkmark indicates an application which has ever been used for the image dataset of imaging protocol 3000. That is, past results indicate that the “subtraction” application can be started using the image dataset of imaging protocol 3000.

In this way, when the image dataset of imaging protocol 3000 is selected, not only a list of adaptive applications, but also the application processing history display section 43 is displayed at the same time, making it possible to select an application which has ever been started using the selected image dataset, and thereby start the application reliably.

The display image of the application processing history displayed in the application processing history display section 43 described above is created based on the application processing history. The application processing history is stored in the application storage unit 21 or the storage unit 20 in a form which allows reference and is updated as appropriate each time the application is started.

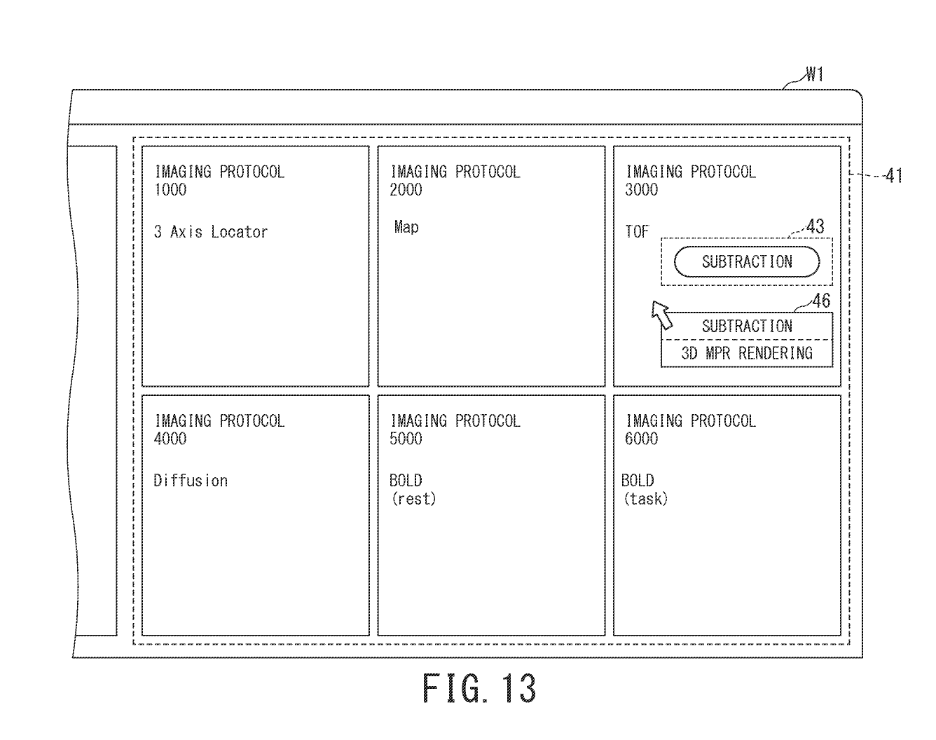

FIG. 13 is a diagram illustrating a second display example of the application processing history display section 43 on the medical diagnostic imaging apparatus 1 according to the exemplary embodiment. As with FIG. 11, FIG. 13 shows part of the image selection screen W1 shown in FIG. 9.

FIG. 12 above shows an example in which an image dataset is selected on the image selection screen W1 and the application processing history display section 43 is displayed simultaneously with a list of adaptive applications. FIG. 13 shows an example in which when a list of image datasets is displayed on the image selection screen W1, the image dataset list display section 41 and application processing history display section 43 are displayed at the same time. As with the example of FIG. 12, FIG. 13 shows an example in which the image dataset of imaging protocol 3000 has already been subjected to image processing by the “subtraction” application. Whereas in FIG. 12, such an application processing history is marked with a checkmark, in the example shown in FIG. 13, a character string which indicates a name of an application is displayed on the image dataset of imaging protocol 3000. In the example shown in FIG. 13, when the image dataset of imaging protocol 3000 is selected in this state, a list of adaptive applications is displayed. The list of adaptive applications displayed in FIG. 13 is identical to the list in FIG. 11.

In this way, as the image dataset and application processing history are displayed simultaneously, it is possible to select an application which has ever been started using the selected image dataset.

Also, although FIGS. 12 and 13 show examples of displaying a history of applications which have ever been used for a selected image dataset, the application processing history display section 43 may display a history of applications which have ever been used for other image datasets or other examination data. For example, a history of applications used for image datasets of other examination data acquired by a same imaging method as the selected image dataset may be displayed in the application processing history display section 43.

Such a display allows the user to select which application to use for the selected image dataset, making it possible to select the application easily.

Furthermore, with the medical diagnostic imaging apparatus 1 according to the present exemplary embodiment, when image processing is interrupted, the interrupted process can be resumed. With the conventional medical diagnostic imaging apparatus, to resume an application in case of such interruption handling, it is necessary to select an image dataset on the image selection screen W1 again, transition to the application selection screen W2, and select an application. On the other hand, according to the present exemplary embodiment, since start data is generated and stored in the start data storage unit 22 when an application is started, the application can be resumed easily using the start data. For example, the start data may be associated with the image dataset processed halfway by the application. Also, a process run by the application may be stored by being associated with the pre-process image dataset, and when the application is resumed using the start data, the stored process may be performed on the image dataset. Also, the start data may be designed to be able to reproduce not only the process performed on the image dataset by the application, but also a display and the like existing at a time of the interruption. For example, a state of tab and button display at the time of the interruption may be stored as start data, allowing the display at the time of the interruption to be reproduced.

Furthermore, the start data may be associated with information other than imaging conditions used in application processes and the image datasets acquired at a time of imaging. Also, the start data may be generated not only upon an interruption of the application, but also before initial startup (before selection of the application). For example, in an fMRI examination, information about a task and state of the patient is recorded simultaneously with MR signals from the patient. An fMRI application performs image processing using information about a task, state, and the like of the patient during imaging. In the case of such an application, it is apparent that the application uses data such as one described above. Thus, the start data may be generated in advance before the initial startup of the application by combining image datasets with the imaging conditions used for the application, imaging-time information, and the like. Also, even at a time of initial startup, if start data already exists, the user may be allowed to start the application by simply selecting the start data.

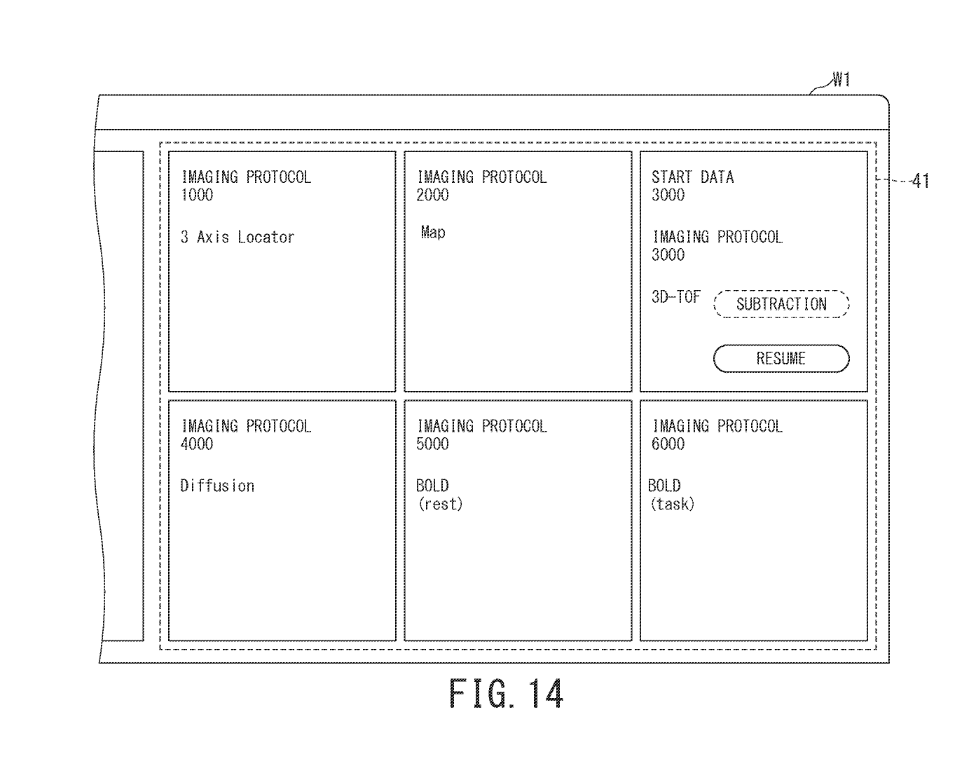

FIG. 14 is a diagram illustrating resumption of image processing on the medical diagnostic imaging apparatus 1 according to the exemplary embodiment. There are cases where an application interruption request is entered via the input unit 50 or the like. FIG. 14 is an example of resuming a process performed by the “subtraction” application with respect to the image dataset of imaging protocol 3000. “Start data 1000” generated based on the image dataset of imaging protocol 3000 is displayed in FIG. 14. A name which uniquely identifies the start data is given to the start data using the order in which, or date on which, the start data is generated.

Also, as described above, the start data is a collection of information on a selected image dataset and selected application. Thus, the imaging protocol number and imaging conditions of the image dataset serving as a basis of the start data may be displayed as well. In the example of FIG. 14, which shows “start data 1000” presented when the “subtraction” application is selected for the image dataset of imaging protocol 3000, character strings of “imaging protocol 3000” and “TOF” are displayed in a frame in which “start data 1000” is displayed.

Start data 1000 may be displayed in the image dataset list display section 41. Also, when displayed in the image dataset list display section 41, start data 1000 may be displayed alone or together with other image datasets. In the example of FIG. 14, start data 1000 is displayed together with other image datasets.

In the example of FIG. 14, a name of a currently running application as well as a Resume button used to resume the application are displayed in the frame where start data 1000 is displayed. When the Resume button is pressed, the application is resumed by the starting unit 35 based on start data 1000.

In this way, use of start data to resume an application makes it possible to avoid switching between the image selection screen W1 and application selection screen W2 which is the case with the conventional medical diagnostic imaging apparatus, and thereby resume the application easily.

### Second Embodiment

The second embodiment involves fist selecting an application to be used.

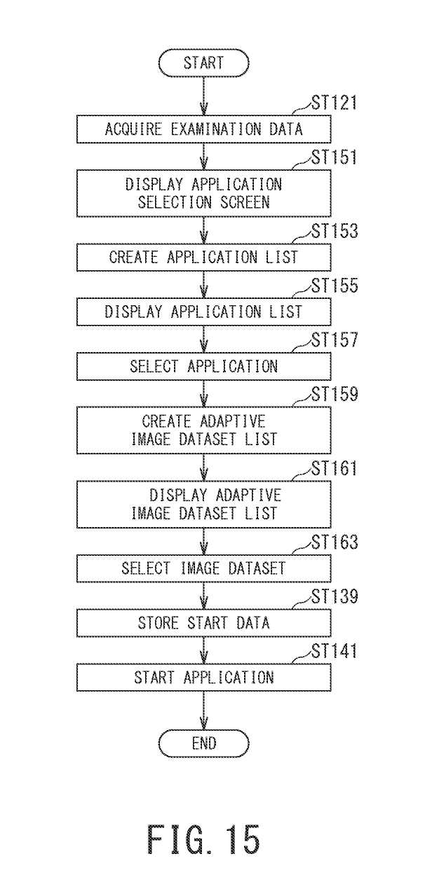

FIG. 15 is a flowchart showing the second embodiment of the medical diagnostic imaging apparatus 1 according to the present exemplary embodiment. The same steps as those in the first embodiment shown in FIG. 8 are denoted by the same step numbers as the corresponding steps in FIG. 8.

In ST121, the data input unit 31 acquires examination data.

In ST151, the user displays the application selection screen W2.

In ST153, the first list creation unit 32 creates a list of all applications stored in the application storage unit 21. As described in the first embodiment, the first list creation unit 32 determines which is the displayed screen and creates a list of applications if the displayed screen is the application selection screen W2.

In ST155, the list of applications created by the first list creation unit 32 is displayed in the application list display section 43.

In ST157, the user selects an application based on the display in the application list display section 43. The application is selected through input via the input unit 50 made up of a mouse and keyboard.

In ST159, based on the adaptability assessment table, the extraction unit 33 extracts image datasets available for use by the selected application. The extraction unit 33 extracts an image dataset by comparing items related to the accompanying information set in the adaptability assessment table of the selected application, the common accompanying information contained in the examination data, and the individual accompanying information on all the image datasets with one another. Based on the image dataset extracted by the extraction unit 33, the second list creation unit 34 creates a list of adaptive image datasets.

In ST161, the list of adaptive image datasets is displayed in the adaptive image dataset list display section 45.

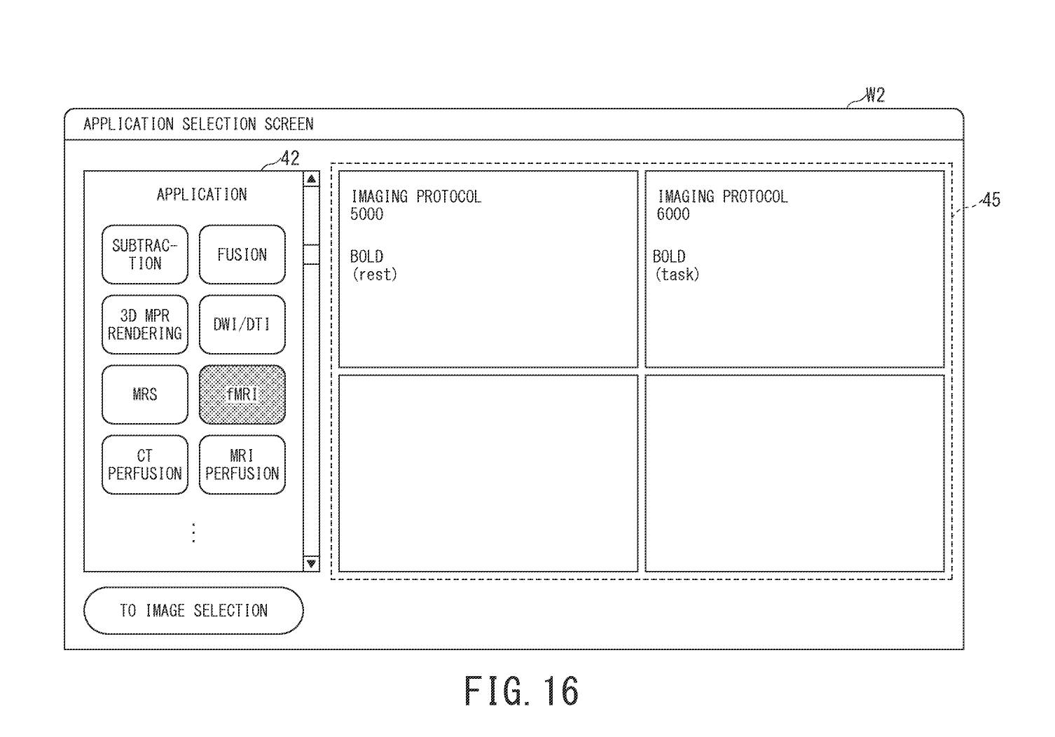

FIG. 16 is a diagram illustrating an example of the adaptive image dataset list display section 45 of the medical diagnostic imaging apparatus 1 according to the exemplary embodiment. In the example shown in FIG. 16, the application selection screen W2 illustrated by example in FIG. 7 is displayed as a single screen. A To Image Selection Screen button is provided in the lower left of FIG. 16, allowing transition to the image selection screen W1.

In the example of FIG. 16, the “fMRI” application selected is indicated by hatching. Once an application is selected on the application selection screen W2, the extraction unit 33 extracts image datasets available for use by the selected application from the acquired examination data. As can be seen from the “fMRI” row of the adaptability assessment table shown in FIG. 10, in the accompanying information on available image datasets, “modality type” is “MRI” and the imaging method is the “BOLD” method. The extraction unit 33 extracts the image datasets whose imaging method is the “BOLD” method, based on the fact that the common accompanying information on the acquired examination data indicates that the modality type used is “MRI” as well as on the individual accompanying information on the image dataset. Thus, the extraction unit 33 extracts imaging protocols 5000 and 6000 whose image datasets are available for use by the “fMRI” application. A list made up of imaging protocols 5000 and 6000 is the list of adaptive image datasets.

As shown on the right side of FIG. 16, the image datasets of imaging protocols 5000 and 6000 are displayed in the adaptive image dataset list display section 45 of the application selection screen W1.

In ST163 of FIG. 15, one image dataset is selected from the list of adaptive image datasets displayed in the adaptive image dataset list display section 45, and the selected information is transmitted to the starting unit 35 via the input unit 50.

In ST139, start data is created by the starting unit 35 and stored in the start data storage unit 22.

In ST141, the starting unit 35 starts the application using the application selected from the list of applications and the image dataset selected from the list of adaptive image datasets, where the list of applications is a first list and the list of adaptive image datasets is a second list.

In this way, if the image datasets available for use by the application selected on the application selection screen W2 are extracted and displayed in the adaptive image dataset list display section 45, the application can be started directly from the application selection screen W2.

Note that as with the first embodiment, according to the second embodiment, in case of application interruption handling, image processing can be resumed using the start data.

Also, as with the first embodiment, according to a variation, a history of image datasets which have ever been processed by the application can be displayed.

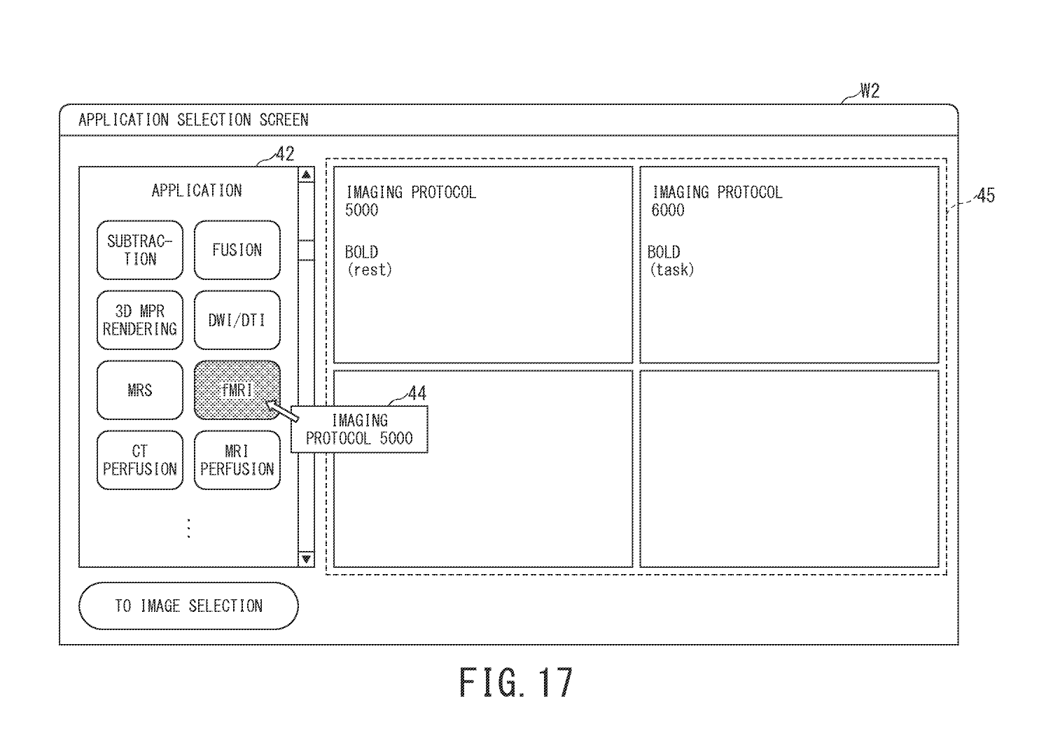

FIG. 17 is a diagram illustrating an example of the image dataset history display section 44 of the medical diagnostic imaging apparatus 1 according to the exemplary embodiment. FIG. 17 shows the application selection screen W2 as in the case of FIG. 16. In FIG. 17, applications are listed on the left side and a list of adaptive image datasets is displayed in the adaptive image dataset list display section 45 on the right side. A display of an image dataset history is created by the image dataset history creation unit 37. In the example of FIG. 17, as with the example of FIG. 16, the “fMRI” application is selected and the image datasets of imaging protocols 5000 and 6000 available for use by the “fMRI” application are displayed in the adaptive image dataset list display section 45. In the example shown in FIG. 17, imaging protocol 5000 has already been processed by the “fMRI” application.

In the example of FIG. 17, the image dataset history display section 44 is displayed on a side of an “fMRI” application button. The image dataset history display section 44 lists the image datasets already processed by the selected application. In the example of FIG. 17, “imaging protocol 5000” is shown on a side of the “fMRI” application button, meaning that “imaging protocol 5000” has already been processed by the “fMRI” application. Usage histories of the image datasets in each application are stored in the accompanying information on the respective image datasets.

Also, the image dataset history display section 44 may display not only the imaging protocol numbers used by the selected application, but also the imaging methods and the like of the image datasets used by the application (not shown). Furthermore, regarding the imaging method display, the imaging methods used by the selected application may be displayed together with other examination data as in the case of the application processing history display section 43 according to the first embodiment.

In this way, by displaying a history of the image datasets used by the selected application, it is possible to reliably select an image dataset which can start the selected application.

As described above, according to the present invention, an item is selected from a first list, which is one of a list of all image datasets and a list of all applications, and then a second list is created listing items thereof able to be combined with the item selected from the first list. This makes it possible to start the application directly from the screen displayed to perform a first selection an item, without a screen transition from the image selection screen W1 or application selection screen W2. Also, to make a second selection from the list generated based on the first selection, choices in making the second selection are narrowed down in advance. Consequently, startup with an incompatible combination of an image dataset and application is avoided. Also, an image dataset and application can be selected easily. Furthermore, an application can be started from any one of the application selection screen and image selection screen, eliminating the need to switch between screens as is conventionally the case.

Furthermore, processes performed by the display control unit 12 of the medical diagnostic imaging apparatus 1 can be performed by an apparatus separate from the medical diagnostic imaging apparatus 1, e.g., by a medical image display apparatus which reads X-rays and displays X-ray images.

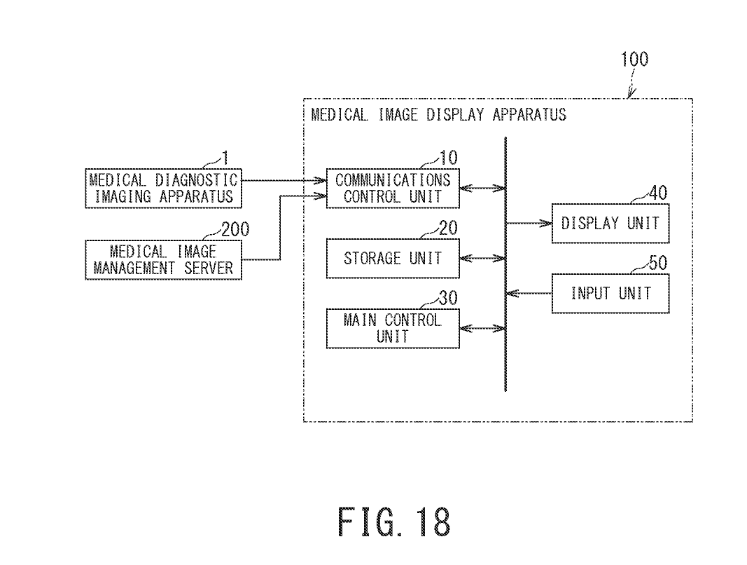

FIG. 18 is a conceptual configuration diagram showing an example of the medical image display apparatus 100 according to the exemplary embodiment. As shown in FIG. 18, the medical image display apparatus 100 includes the communications control unit 10, storage unit 20, main control unit 30, display unit 40, and input unit 50.

The medical image display apparatus 100 is connected to a consolidated medical image management server 200 and the medical diagnostic imaging apparatus 1 through an electronic network via the communications control unit 10. The communications control unit 10 supports various communications protocols according to network configurations.

Examples of the medical diagnostic imaging apparatus 1 include various medical diagnostic imaging apparatus such as a general radiographic X-ray apparatus, X-ray CT (Computed Tomography) apparatus, MRI (Magnetic Resonance Imaging) apparatus, PET (Positron Emission Tomography) apparatus, and ultrasound diagnostic apparatus.

Examination data acquired by the medical image display apparatus 100 may be any of examination data acquired by the medical diagnostic imaging apparatus 1 including X-ray images taken by a general radiographic X-ray apparatus, multi-slice images taken by an X-ray CT apparatus, MRI apparatus, PET apparatus, and the like, and ultrasound images taken by an ultrasound diagnostic apparatus.

When a program stored in the storage unit 20 is executed by the main control unit 30, postprocessing applications applicable to the image datasets described above are extracted and displayed and the image datasets available for use by a selected application are displayed. Also, the application is started by a combination of a selected image dataset and the application.

With the configuration shown in FIG. 18, the medical image display apparatus 100 provides advantages similar to those of the medical diagnostic imaging apparatus 1.

1. A medical diagnostic imaging apparatus comprising:
an execution unit configured to execute a plurality of imaging protocols included in an examination; and
a display control unit configured to display a first screen and a second screen, where the first screen selectably displays a plurality of image datasets collected based on the respective imaging protocols after execution of the plurality of imaging protocols as well as extracts and displays postprocessing applications applicable to individual ones of the image datasets while the second screen is brought up by transitioning from the first screen and used to perform postprocessing of the image datasets, wherein
when an application associated with a predetermined image dataset is selected on the first screen, the display control unit starts the selected application and transitions from the first screen to the second screen to perform postprocessing of the predetermined image dataset.

2. The medical diagnostic imaging apparatus according to claim 1, wherein when the application is selected on the second screen earlier than an image dataset, the display control unit displays image datasets processable by the selected application, on the second screen.

3. The medical diagnostic imaging apparatus according to claim 1, further comprising an extraction unit configured to extract, from the plurality of applications, one or more adaptive applications suitable for processing an image dataset selected from the plurality of image datasets,
wherein examination data which is a collection of the plurality of image datasets contains, in addition to the image datasets, accompanying information which includes at least information about a type of modality apparatus and an imaging method used to acquire the image datasets; and
the extraction unit extracts the adaptive application(s) or an adaptive image dataset based on an adaptability assessment table which prescribes combinations of the applications and the accompanying information on the image datasets.

4. The medical diagnostic imaging apparatus according to claim 1, further comprising:
an image dataset list display section configured to display a list of the plurality of image datasets, allowing one image dataset to be selected from the list of the plurality of image datasets; and
an adaptive application list display section configured to display a list of the one or more adaptive applications, allowing the one adaptive application to be selected from the list of the one or more adaptive applications.

5. The medical diagnostic imaging apparatus according to claim 2, further comprising:
an application list display section configured to display a list of a plurality of applications, allowing the one application to be selected from the list of the plurality of applications; and
an adaptive image dataset list display section configured to display a list of one or more adaptive image datasets, allowing one adaptive image dataset to be selected from the list of the one or more adaptive image datasets.

6. The medical diagnostic imaging apparatus according to claim 1, wherein the accompanying information includes an application processing history of applications used for the image datasets, and
the medical diagnostic imaging apparatus further comprises:
an application processing history creation unit configured to create the processing history of applications; and
an application processing history display section configured to display the application processing history.

7. The medical diagnostic imaging apparatus according to claim 2, further comprising:
an image dataset history creation unit configured to create a usage history of the image datasets, based on a history of image datasets processed by each of the applications; and
an image dataset history display unit configured to display a usage history of image datasets.

8. The medical diagnostic imaging apparatus according to claim 1, further comprising a start data storage unit configured to store a combination of the application and the image dataset, the combination being used to start the application when image processing by the application is interrupted, wherein
the display control unit resumes image processing by starting the application using the combination stored in the start data storage unit.

9. A medical image display apparatus comprising:
an execution unit configured to execute a plurality of imaging protocols included in an examination; and
a display control unit configured to display a first screen and a second screen, where the first screen selectably displays a plurality of image datasets collected based on the respective imaging protocols after execution of the plurality of imaging protocols as well as extracts and displays postprocessing applications applicable to individual ones of the image datasets while the second screen is brought up by transitioning from the first screen and used to perform postprocessing of the image datasets, wherein
when an application associated with a predetermined image dataset is selected on the first screen, the display control unit starts the selected application and transitions from the first screen to the second screen to perform postprocessing of the predetermined image dataset.

10. A medical image display method comprising:
executing a plurality of imaging protocols included in an examination; and
displaying a first screen and a second screen, where the first screen selectably displays a plurality of image datasets collected based on the respective imaging protocols after execution of the plurality of imaging protocols as well as extracts and displays postprocessing applications applicable to individual ones of the image datasets while the second screen is brought up by transitioning from the first screen and used to perform postprocessing of the image datasets, wherein
when an application associated with a predetermined image dataset is selected on the first screen, the display control unit starts the selected application and transitions from the first screen to the second screen to perform postprocessing of the predetermined image dataset.
